(19) United States
(12) Patent Application Publication
(10) Pub. No.: US 2014/0255259 A1
(43) Pub. Date: Sep. 11, 2014

(54) HYDROGEN-PRODUCING CATALYTIC CONVERTER

(71) Applicant: PROMETHEUS ENERGY TECHNOLOGY CO., Taipei (TW)

(72) Inventors: Hui-Wen FENG, Taipei (TW); Yaw-Chung CHENG, Taipei (TW)

(73) Assignee: Prometheus Energy Technology Co., Taipei (TW)

(21) Appl. No.: 13/786,583

(22) Filed: Mar. 6, 2013

(51) Int. Cl. B01D 53/94

(52) U.S. Cl. CPC B01D 53/94
USPC 422/119; 422/173

(57) ABSTRACT

A hydrogen-producing catalytic converter is arranged in an exhaust pipe of an engine to absorb heat from engine waste gas for actuating hydrogen production, and includes a preheating body and a catalyst bed enclosed in a heating pipe, and a plurality of heating catalysts filled between the heating pipe and the preheating body and the catalyst bed. The heating pipe has two closed ends, one of which has a gas inlet pipe connected thereto to communicate the heating pipe with a combustion gas tank, from which an oxygen-containing combustion gas is supplied into the heating pipe to heat the heating catalysts. The heating catalysts in turn heat hydrogen-producing catalysts in the catalyst bed to a working temperature thereof, so that an engine hydrogenation process can be performed as soon as the engine is started to ensure reduced air pollution and fuel consumption in the whole course of engine operation.

### FIELD OF THE INVENTION

The present invention relates to a hydrogen-producing catalytic converter, and more particularly to a catalytic converter that is arranged in an exhaust pipe of an internal combustion engine to absorb engine waste heat in an upgraded efficiency for producing hydrogen gas and delivering the produced hydrogen gas into the engine, so that fuel in the engine can be completely burned to reduce air pollution and save fuel.

### BACKGROUND OF THE INVENTION

Cars are traffic means that highly relay on petroleum fuel and accordingly main sources of greenhouse gas emission. Therefore, car carbon reduction and energy saving has become an important policy in many countries.

To achieve good ignition and combustion efficiency of fuel, the internal combustion engine for a car is generally set to its optimal air-fuel ratio (AFR) in the car plant. Usually, the optimal AFR, or briefly referred to as “Value A”, is between 14.5:1 and 15.0:1, helps in obtaining the maximum combustion efficiency of fuel in the engine. Many internationally famous car manufacturers use high-precision control systems in the production of fuel-saving cars to set the air-fuel ratio close to the Value A in mixing fuel with air.

The higher AFR indicates less fuel is contained in the air-fuel mixture to achieve the purpose of fuel saving. However, the higher AFR tends to cause unstable engine operation and engine knocking as well as insufficient horsepower. In the case of having an AFR larger than the Value A, it means the fuel in the engine is relatively lean. Under this condition, lean combustion in the engine after ignition will occur. The lean combustion will cause lag explosion and accordingly, detonation in the engine, resulting in unsmooth engine operation. When the detonation in engine occurs, the car will vibrate violently to have lowered engine efficiency and the risk of a stalled engine. Further, both the car body and in-car systems are subjected to damage due to the engine detonation.

Fuel supplied from a fuel tank and air fed in via an intake manifold are mixed with each other before the fuel-air mixture enters the engine and is ignited to burn, explode, and push the piston in the engine to work. During the process of burning, about ⅓ of the fuel is not completely burned but is discharged along with exhaust gas via an exhaust pipe to cause air pollution. When the AFR is too low, incomplete combustion of fuel tends to occur to thereby produce high pollution-causing exhaust emission, which will badly affect the quality of ambient air to endanger the environmental protection.

Since hydrogen has a relative low energy level of 0.017 MJ compared to the gasoline's energy level of 0.29 MJ, it can burn quickly. The burning hydrogen has a flame speed of 3.2-4.4 M/s, which is much faster than the flame speed of 0.34 M/s of gasoline. Therefore, by feeding hydrogen into the internal combustion engine, the fuel's combustion efficiency in engine can be upgraded by the burning hydrogen in the engine. With the increased fuel combustion efficiency, the fuel that was originally not able to burn completely can be now completely burned instantaneously to eliminate engine detonation. Under this condition, the carbon content in the exhaust emission is reduced to minimize air pollution.

### SUMMARY OF THE INVENTION

A primary object of the present invention is to provide a hydrogen-producing catalytic converter that utilizes waste heat from an engine for actuating a hydrogen production process, so that hydrogen-producing catalysts in the catalytic converter can reach a working temperature thereof to produce hydrogen even when the engine is not in operation, and an engine hydrogenation process can be performed as soon as the engine is started. In this manner, the purposes of reducing air pollution and saving fuel can be achieved during the whole course of engine operation.

Another object of the present invention is to provide a hydrogen-producing catalytic converter that is arranged in an exhaust pipe of an engine and can reach a working temperature of hydrogen-producing catalysts to enable an engine hydrogenation process even when the engine is idling, so as to exactly achieve the purposes of reducing air pollution and saving fuel.

To achieve the above and other objects, the hydrogen-producing catalytic converter according to the present invention is arranged in an expanded section of an exhaust pipe of an engine to absorb heat from engine waste gas for actuating hydrogen production, and includes a preheating body, a catalyst bed, a heating pipe fitted around the preheating body and the catalyst bed, and a plurality of heating catalysts filled between the heating pipe and the preheating body and the catalyst bed. The heating pipe has two closed ends, one of which has a gas inlet pipe connected thereto to communicate the heating pipe with a combustion gas tank, from which an oxygen-containing combustion gas can be supplied into the heating pipe to heat the heating catalysts. The heating catalysts in turn heat hydrogen-producing catalysts in the catalyst bed to a working temperature thereof. The other end of the heat pipe is provided with pressure relief vents.

In the hydrogen-producing catalytic converter according to the present invention, the preheating body is internally provided with a preheating duct; the catalyst bed is provided with a molecular rearrangement duct, a coolant conveying duct, a first temperature sensor, and a second temperature sensor. The molecular rearrangement duct has hydrogen-producing catalysts provided therein. The preheating duct in the preheating body has an end communicating with a fuel-water tank and another end communicating with the molecular rearrangement duct of the catalyst bed. The molecular rearrangement duct of the catalyst bed is communicable with an intake manifold of the engine via a hydrogen adding pipeline, so that the produced hydrogen gas can be delivered into the engine via the hydrogen adding pipeline. The coolant conveying duct of the catalyst bed is communicable with a coolant tank.

The oxygen-containing combustion gas is supplied into the heating pipe by an air pump. The combustion gas is methanol steam.

A fuel-water solution is supplied from the fuel-water solution tank into the preheating duct in the preheating body when the first temperature sensor detects a temperature reaching a working temperature of the hydrogen-producing catalysts for hydrogen production; and a coolant is supplied from the coolant tank into the coolant conveying duct in the catalyst bed when the second temperature sensor detects a temperature reaching a safe temperature preset for the hydrogen-producing catalysts.

The preheating body and the catalyst bed are welded together to form an integral unit. The preheating body and the catalyst bed are provided on around their outer wall surfaces with at least three angularly equally spaced and axially extended support wings, and the heating pipe is correspondingly provided on its inner wall surface with axially extended engaging slot. Through engagement of the support wings with the engaging slots, the preheating body and the catalyst bed are fixedly held in place in the heating pipe.

The support wings are respectively provided with a hole. With the holes provided on the support wings, gases in the heating pipe are allowed to flow laterally without being blocked by the support wings.

The exhaust pipe section is provided on around its wall near both front and rear ends thereof with at least three angularly equally spaced screws, which radially extend into the exhaust pipe section to press against front and rear end portions of the heating pipe, so that the heating pipe is fixedly held in the exhaust pipe section by the screws.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a system structural view of a hydrogenation system for engine, in which a hydrogen-producing catalytic converter according to the present invention is employed;

FIG. 2 is an enlarged, fragmentary and partial sectional view of FIG. 1 showing the installation of the hydrogen-producing catalytic converter of the present invention in an exhaust pipe section of an engine;

FIG. 3 is a perspective view of the hydrogen-producing catalytic converter according to a preferred embodiment of the present invention;

FIG. 4 is a perspective view of a catalyst bed and a preheating body included in the hydrogen-producing catalytic converter of the present invention;

FIG. 5 is a sectional view taken along line A-A of FIG. 2;

FIG. 6 is a sectional view taken along line B-B of FIG. 5;

FIG. 7A is a front view of the catalyst bed shown in FIG. 4;

FIG. 7B is a rear view of the catalyst bed shown in FIG. 4;

FIG. 8A is a front view of the preheating body shown in FIG. 4;

FIG. 8B is a rear view of the preheating body shown in FIG. 4;

FIG. 9 is a developed view taken along line C-C of FIG. 8A;

FIG. 10 is a developed view taken along line D-D of FIG. 7A; and

FIG. 11 is a developed view taken along line E-E of FIG. 7A.

### DETAILED DESCRIPTION OF THE PREFERRED EMBODIMENTS

The present invention will now be described with a preferred embodiment thereof and with reference to the accompanying drawings.

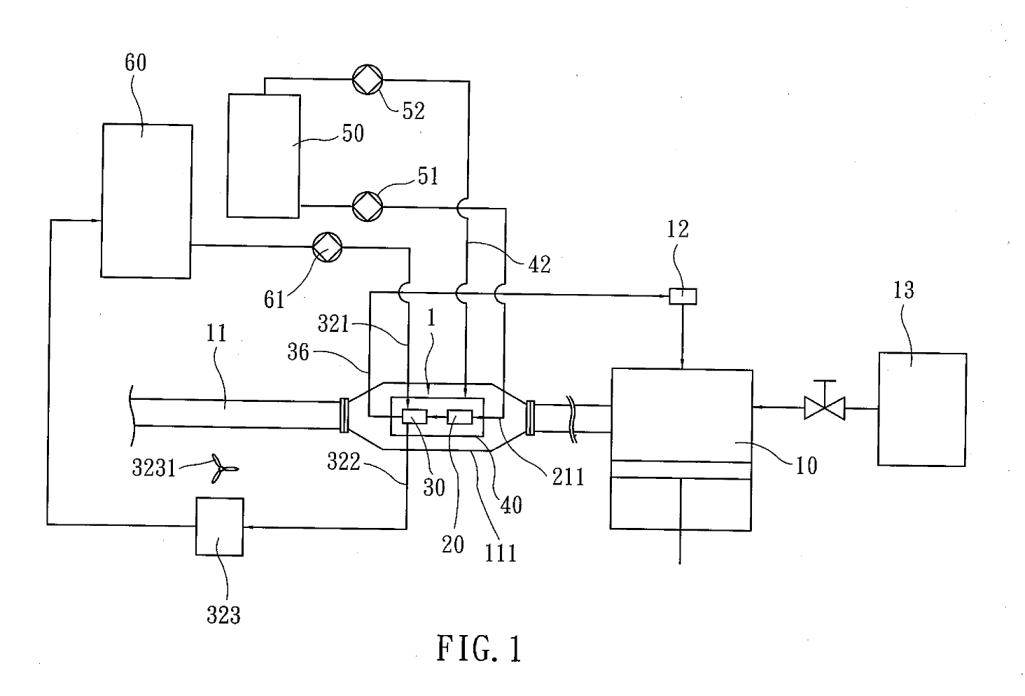

Please refer to FIG. 1 that is a system structural view of a hydrogenation system for engine, in which a hydrogen-producing catalytic converter 1 according to the present invention is employed. For the purpose of conciseness and clarity, the hydrogen-producing catalytic converter 1 of the present invention is also briefly referred to the catalytic converter 1 herein. As shown, the catalytic converter 1 is installed in an exhaust pipe section 111 to absorb heat from waste gas of an engine 10 and is actuated by the absorbed heat to produce hydrogen. The heated catalytic converter 1 leads to a molecular rearrangement reaction in a fuel-water solution containing hydrogen atoms to thereby produce hydrogen gas and carbon dioxide gas, which are delivered into the engine 10 via an intake manifold 12 of the engine 10 to be burned along with a fuel in the engine 10 after the latter is ignited. Since hydrogen gas has a relatively low combustion energy level and can burn quickly, the feeding of hydrogen gas into the engine 10 can help in the fully burning of the fuel in the engine 10, which in turn helps in purifying the engine exhaust gas to reduce air pollution. By feeding hydrogen gas into the engine 10, a lean fuel with relative high AFR in the engine 10 can be completely burned to thereby enable reduced fuel consumption and avoid engine knocking due to delayed combustion in the engine 10.

The exhaust pipe section 111 is one part of an exhaust pipe 11 of the engine 10 and has an expanded diameter, so that the engine 10 with the catalytic converter 1 installed in the exhaust pipe section 111 still has an engine displacement satisfying the car or the generator manufacturer's original design.

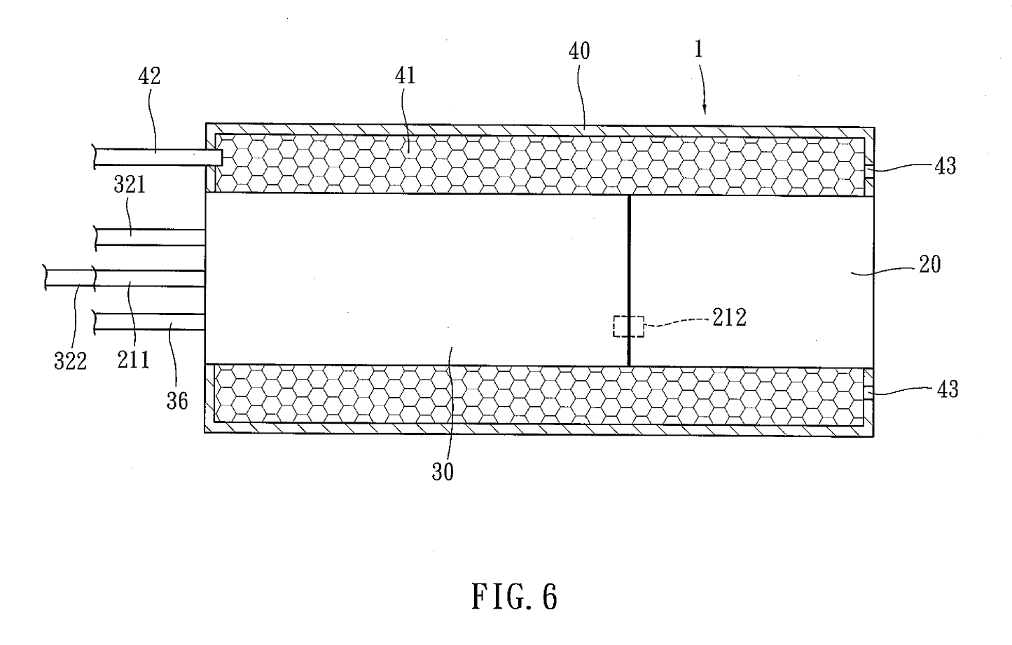

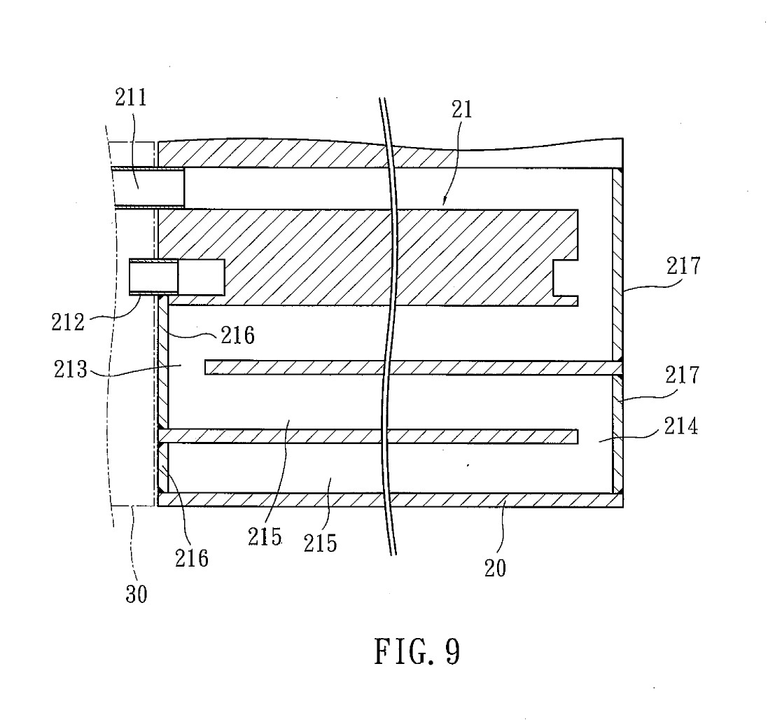

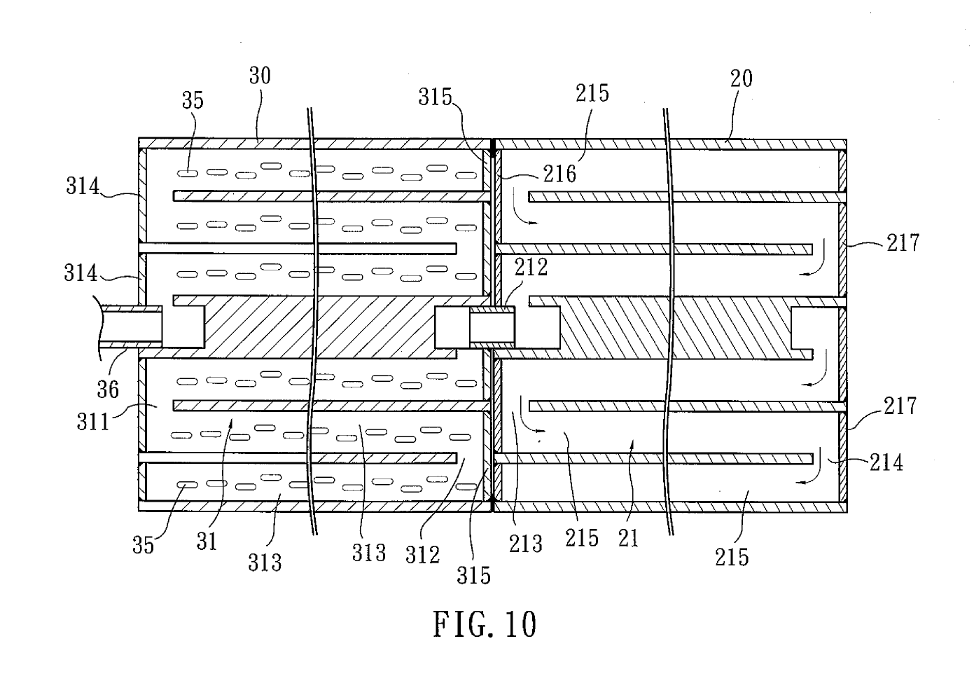

Please refer to FIGS. 1 to 5. The catalytic converter 1 includes a preheating body 20, a catalyst bed 30, a heating pipe 40, and a plurality of heating catalysts 41. The heating catalysts 41 can be platinum catalysts. The catalyst bed 30 and the preheating body 20 are arranged end-to-end in the exhaust pipe section 111 with the preheating body 20 located closer to the engine 10. There is a preheating duct 21 embedded in the preheating body 20, as shown in FIG. 9. The preheating duct 21 has an end communicating with a tank 50, in which an amount of fuel-water solution is stored, and another opposite end communicating with a molecular rearrangement duct 31 in the catalyst bed 30, as shown in FIG. 10. The fuel-water solution is supplied from the tank 50 to the preheating body 20 via control of a liquid pump 51, which is controlled to open or close by a thermostatic switch. The fuel-water solution can be a methanol-water solution, and the tank 50 is used to store the methanol-water solution therein. The methanol-water solution can be pumped out by the liquid pump 51 and delivered from the tank 50 into the preheating duct 21 in the preheating body 20. The methanol-water solution delivered into the preheating duct 21 is quickly heated and vaporized into high-temperature gas because the preheating body 20 has been preheated by heat absorbed from the engine waste gas. The preheating duct 21 is connected to an inlet pipe 211 and an outlet pipe 212 (see FIG. 6). As can be seen in FIG. 1, the catalytic converter 1 is also connected to a hydrogen adding pipeline 36, a coolant conveying pipeline 321, a back flow pipeline 322, and a fuel tank 13.

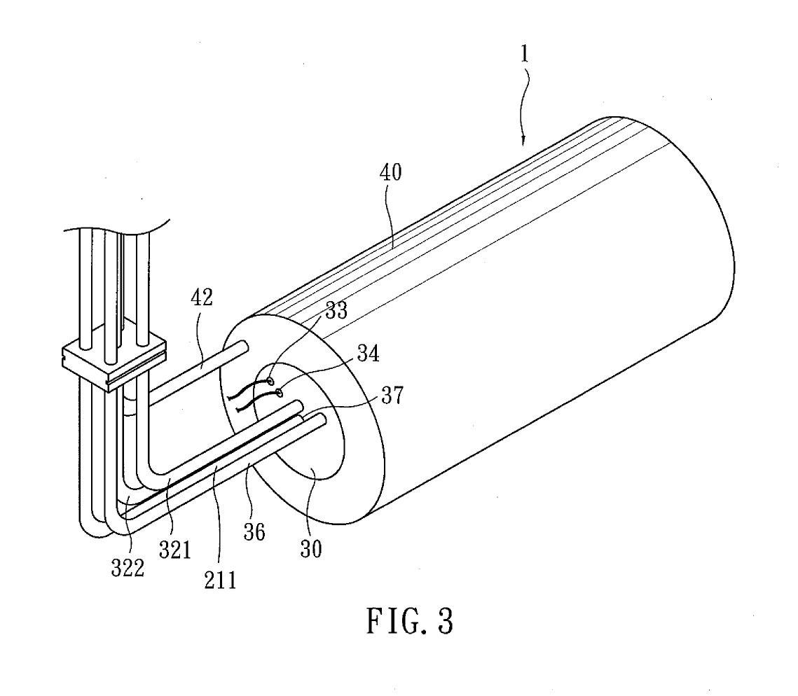

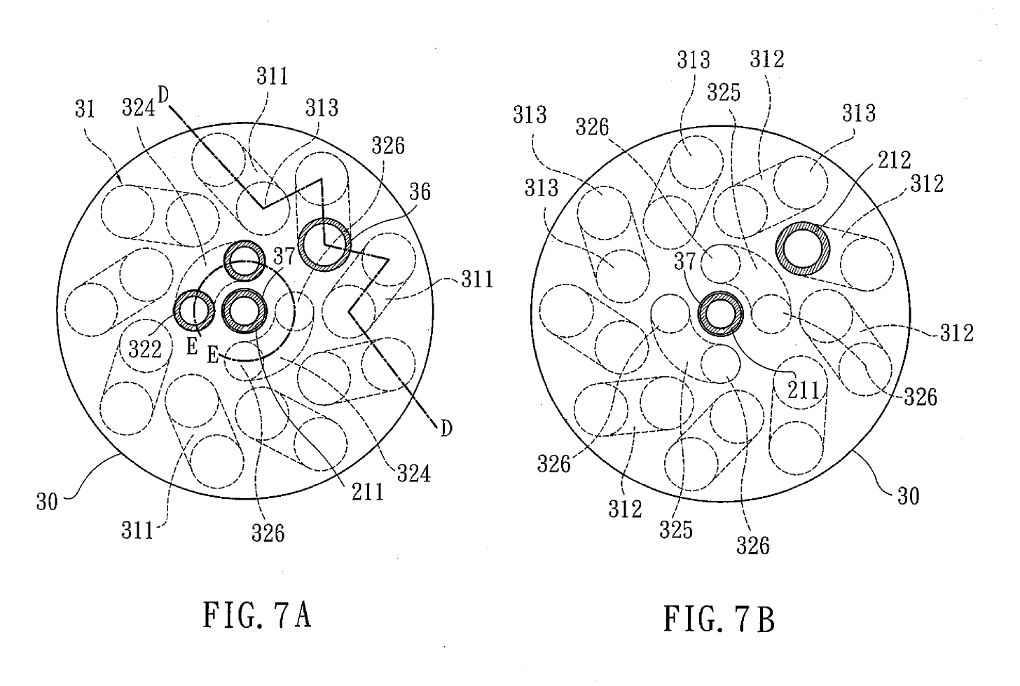

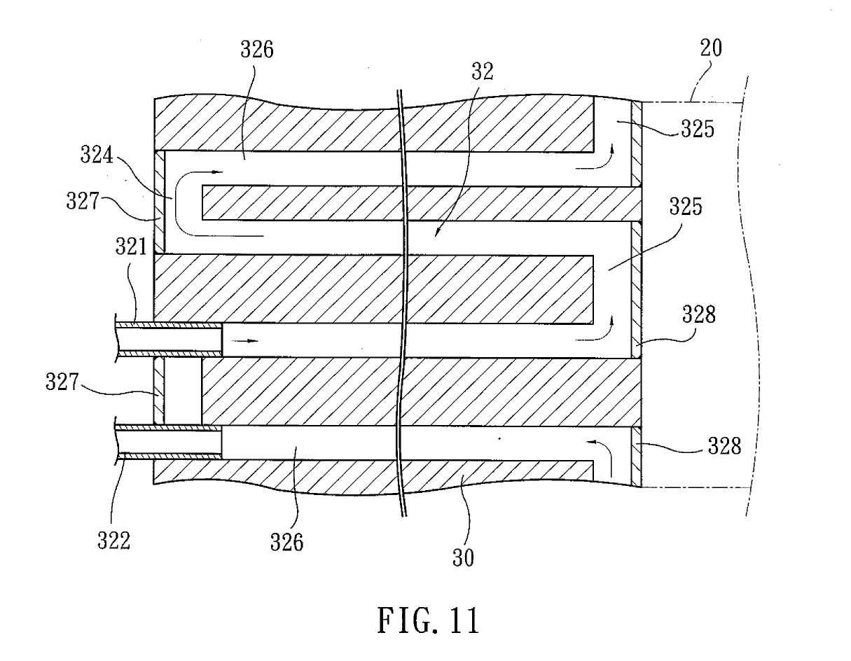

Please also refer to FIGS. 7A, 7B, 10 and 11. The catalyst bed 30 includes a molecular rearrangement duct 31, a coolant conveying duct 32 (see FIG. 11) and a first and a second temperature sensor 33, 34 (see FIG. 3). The molecular rearrangement duct 31 is internally provided with a plurality of hydrogen-producing catalysts 35, which can be CuZn-based catalysts, and is communicable with the preheating duct 21 in the preheating body 20 via the outlet pipe 212. Meanwhile, the molecular rearrangement duct 31 of the catalyst bed 30 is communicable with the intake manifold 12 of the engine 10 via the hydrogen adding pipeline 36. The catalyst bed 30 absorbs the heat in the engine waste gas to thereby heat the catalysts 35 in the molecular rearrangement duct 31 to a working temperature of the catalysts 35. With the catalysts 35 being heated to its working temperature, a molecular rearrangement reaction occurs in the high-temperature gas-phase fuel-water solution flowing into the molecular rearrangement duct 31 to produce hydrogen gas and carbon dioxide gas, which are then conveyed through the hydrogen adding pipeline 36 and the intake manifold 12 into the engine 10 for performing an engine hydrogenation process in the engine 10.

Please refer to FIGS. 1, 2 and 7A at the same time. The coolant conveying duct 32 in the catalyst bed 30 is communicable with a coolant tank 60 having an amount of coolant stored therein, so that the coolant can be timely delivered from the coolant tank 60 into the coolant conveying duct 32 to lower the catalyst bed's temperature and accordingly, avoid the risk of having overheated and damaged catalysts 35 that are required in the molecular rearrangement reaction. The coolant can be water. In the illustrated preferred embodiment of the present invention, the working temperature of the catalysts 35 is set to 220° C., and the catalysts 35 adopted in the present invention can resist a high temperature of 350° C. However, to prevent the catalysts 35 from being damaged due to overheating, a safe temperature of 280° C. is preset for the catalyst bed 30 in the present invention, so that the coolant is supplied to lower the temperature of the catalyst bed 30 as soon as the safe temperature of 280° C. is reached. When the first temperature sensor 33 detects that the catalysts 35 have reached the preset working temperature of 220° C. for producing hydrogen, the methanol-water solution is immediately delivered into the catalyst bed 30 via the preheating pipe 21 in the preheating body 20 to enable hydrogen production and engine hydrogenation process. And, when the second temperature sensor 34 detects that the catalysts 35 have reached the safe temperature of 280° C., the liquid pump 61 is immediately actuated for delivering the coolant into the catalyst bed 30 to lower the latter's temperature and protect the catalysts 35 against damage.

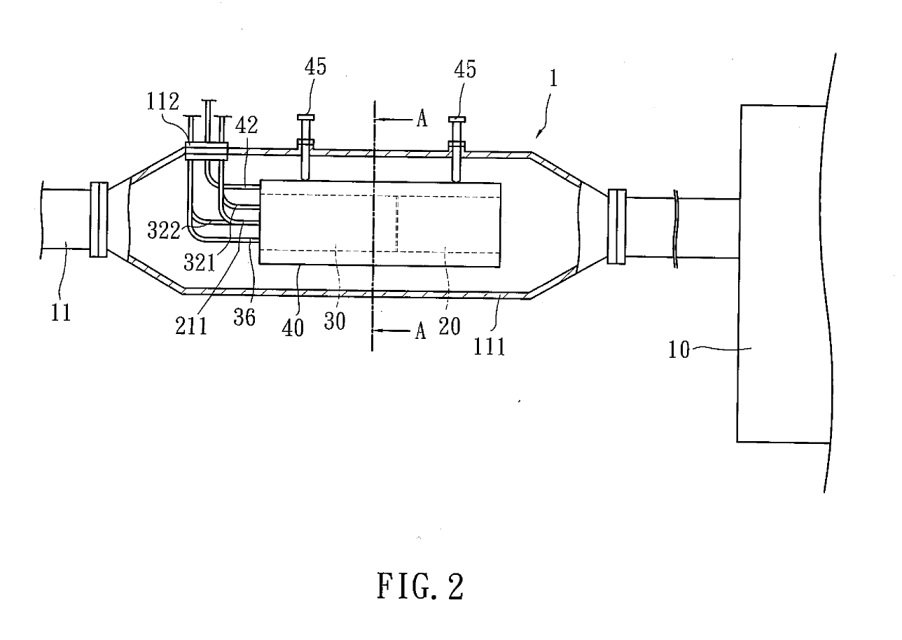

Please refer to FIGS. 1 to 3, 5 and 6. The catalyst bed 30 and the preheating body 20 are made of a metal material with good thermal conductivity, and they are welded together to form an integral unit. The heating pipe 40 is externally fitted around the preheating body 20 and the catalyst bed 30. The heating catalysts 41 are filled between the heating pipe 40 and the preheating body 20 and the catalyst bed 30. The heating pipe 40 has two closed ends. A gas inlet pipe 42 is connected to one end of the heating pipe 40 to communicate the heating pipe 40 with a combustion gas tank 50, so that a type of oxygen-contain combustion gas can be delivered from the combustion gas tank 50 into the heating pipe 40. The other end of the heating pipe 40 is provided with pressure relief vents 43, via which high-temperature gas in the heating pipe 40 can be released to protect the heating pipe 40 against burst due to excessive internal pressure thereof. The heating catalysts 41 in contact with the oxygen-containing combustion gas will have a raised temperature to heat the catalyst bed 30 and the preheating body 20. The supply of the oxygen-containing combustion gas immediately stops when the second temperature sensor 34 detects that the catalyst bed 30 has a temperature reaching 220° C. The above-mentioned inlet pipe 211, coolant conveying pipeline 321, back flow pipeline 322, hydrogen adding pipeline 36 and gas inlet pipe 42 all are extended through the same one mounting plate 112 (see FIG. 2), which is mounted on and welded to the exhaust pipe section 111.

The combustion gas can be methanol steam, such as the methanol steam in the tank 50. The oxygen-containing combustion gas is pumped into the heating pipe 40 by an air pump 52. The air pump 52 can be actuated with only very low power without causing too much power consumption. With these arrangements, the first temperature sensor 33 on the catalyst bed 30 can detect the catalysts 35 at their working temperature of 220° C. as soon as a car is started, and the methanol-water solution can be immediately delivered to the catalytic converter 1 for hydrogen production and subsequent engine hydrogenation process. Meanwhile, with the present invention, the catalyst bed 30 can also maintain at a temperature higher than 220° C. for hydrogen production and subsequent engine hydrogenation process even when the car is idling. Therefore, with the present invention, the engine hydrogenation process can continue during the whole course of car driving or engine operation to fully achieve the purposes of reducing air pollution and saving fuel.

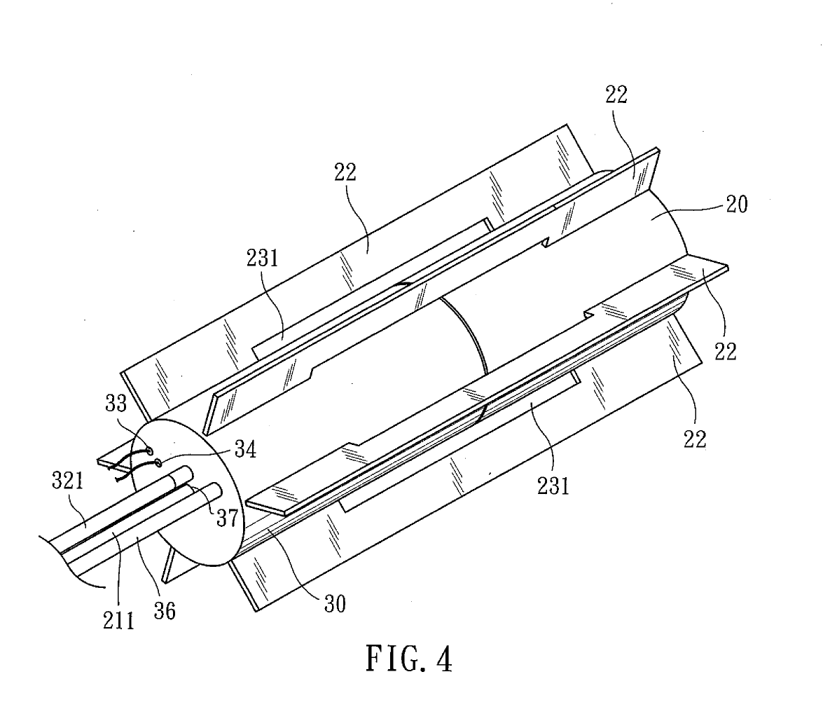

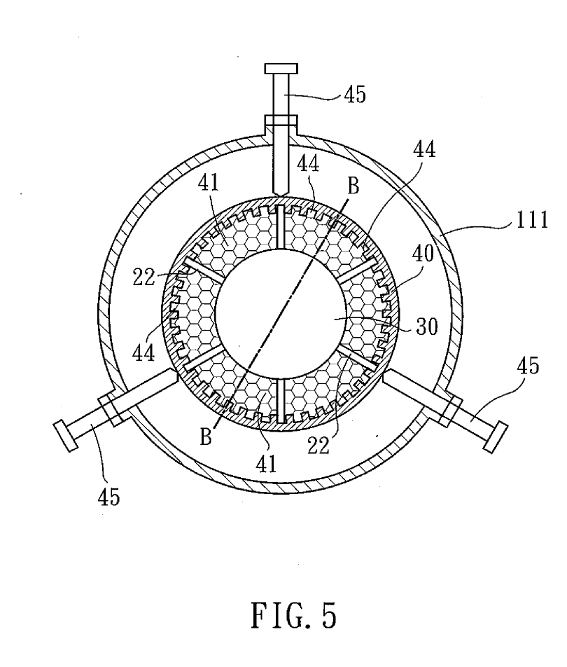

As can be seen in FIGS. 4 and 5, at least three angularly equally spaced and axially extended support wings 22 are provided on around outer wall surfaces of the preheating body 20 and the catalyst bed 30. In the illustrated preferred embodiment, there are six support wings 22. The heating pipe 40 is correspondingly provided on its inner wall surface with axially extended engaging slots 44, with which the support wings 22 can engage to thereby hold the preheating body 20 and the catalyst bed 30 in place in the heating pipe 40. The support wings 22 are respectively provided with a hole 231, with which gases in the heating pipe 40 are allowed to flow laterally without being blocked by the support wings 22.

As can be seen in FIGS. 2 and 5, the exhaust pipe section 111 is provided on around its wall near both front and rear ends thereof with at least three angularly equally spaced screws 45, which radially extend into the exhaust pipe section 111 to press against front and rear end portions of the heating pipe 40, so that the heating pipe 40 is fixedly held in the exhaust pipe section 111 by the screws 45.

The catalyst bed 30 has an axially extended central hole 37, into which the inlet pipe 211 is extended for supplying the methanol-water solution into the catalyst bed 30. The molecular rearrangement duct 31 in the catalyst bed 30 is a zigzag duct formed of a plurality of sequentially communicable duct sections. The zigzag molecular rearrangement duct 31 allows the vaporized fuel-water solution to contact with the catalysts 35 for longer time to ensure upgraded hydrogen production efficiency. Please refer to FIGS. 7A, 7B and 10. The catalyst bed 30 is provided at a front end surface (i.e. the end surface opposite to the preheating body 20) and a rear end surface closer to a radially outer portion with a plurality of front and rear recesses 311, 312, respectively. Every front and rear recess 311, 312 is provided with two axially extended through holes 313. The two through holes 313 at any one of the front recesses 311 are communicable with two adjacent rear recesses 312. After the front recesses 311 and the rear recesses 312 of the catalyst bed 30 are closed by front sealing plates 314 and rear sealing plates 315, respectively, the zigzag molecular rearrangement duct 31 consisting of a plurality of duct sections is formed in the catalyst bed 30. The front sealing plates 314 and the rear sealing plates 315 are fixed to the front and the rear end surface of the catalyst bed 30 by way of full welding along peripheral edges of the sealing plates 314, 315. The molecular rearrangement duct 31 has an inlet communicating with the outlet pipe 212, which is connected to the preheating duct 21 of the preheating body 20, and an outlet communicating with the hydrogen adding pipeline 36. Similarly, the coolant conveying duct 32 in the catalyst bed 30 is a zigzag duct formed of a plurality of duct sections. Please refer to FIGS. 7A, 7B and 11 at the same time. The catalyst bed 30 is provided at the front end surface and the rear end surface closer to a radially inner portion with a plurality of front and rear recesses 324, 325, respectively. Every front and rear recess 324, 325 is provided with two axially extended through holes 326. The two through holes 326 at any one of the front recesses 324 are communicable with two adjacent rear recesses 325. After the front recesses 324 and the rear recesses 325 of the catalyst bed 30 are closed by front sealing plates 327 and rear sealing plates 328, respectively, the zigzag coolant conveying duct 32 consisting of a plurality of duct sections is formed in the catalyst bed 30.

Please refer to FIGS. 1 and 11. The back flow pipeline 322 is part of the coolant conveying pipeline 321. The coolant flowing out of the catalyst bed 30 is collected and conveyed by the back flow pipeline 322 back into the coolant tank 60 for coolant recycling. The back flow pipeline 322 is provided with a cooler 323 for lowering the high temperature of the heat-absorbed coolant before the coolant is recycled. The cooler 323 dissipates heat via air cooling. That is, when the car moves at high speed, the cold ambient air exchanges heat with the cooler 323. The cooler 323 can further include a cooling fan 3231. The coolant can be water, or heat-resistant oil or other heat-resistant liquid.

The preheating duct 21 in the preheating body 20 can be a spiral copper tube or a zigzag duct consisting of a plurality of sequentially communicable duct sections.

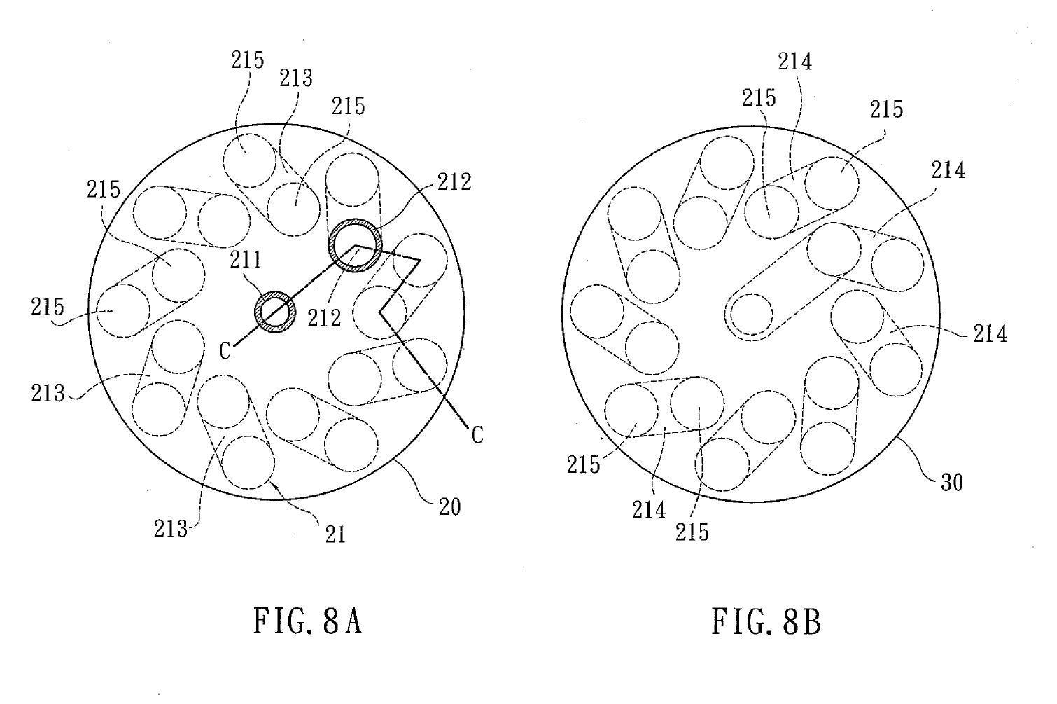

Please refer to FIGS. 8A, 8B, 9 and 10 at the same time. The preheating body 20 is provided at a front end surface (i.e. the end surface adjacent to the catalyst bed 30) and a rear end surface closer to a radially outer portion with a plurality of front and rear recesses 213, 214, respectively. Every front and rear recess 213, 214 is provided with two axially extended through holes 215. The two through holes 215 at any one of the front recesses 213 are communicable with two adjacent rear recesses 214. After the front recesses 213 and the rear recesses 214 of the preheating body 20 are closed by front sealing plates 216 and rear sealing plates 217, respectively, the zigzag preheating duct 21 consisting of a plurality of duct sections is formed in the preheating body 20.

By providing the catalytic converter 1 of the present invention with the heating pipe 40 and the heating catalysts 41, the catalysts 35 in the catalyst bed 30 can always reach the working temperature thereof even when the engine 10 is not started or is idling. Therefore, the engine hydrogenation process can be performed as soon as the engine 10 is started to ensure the purposes of reducing air pollution and saving fuel in the whole course of car driving or engine operation.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A hydrogen-producing catalytic converter arranged in an expanded section of an exhaust pipe of an engine to absorb heat from engine waste gas for actuating hydrogen production, comprising:
a catalyst bed including a molecular rearrangement duct and a coolant conveying duct; the molecular rearrangement duct being communicable with an intake manifold of the engine via a hydrogen adding pipeline and having a plurality of hydrogen-producing catalysts provided therein, and the coolant conveying duct being communicable with a coolant tank;
a preheating body having a preheating duct embedded therein; the preheating duct having an end communicating with a fuel-water solution tank and another end communicating with the molecular rearrangement duct in the catalyst bed; and the preheating body and the catalyst bed being arranged end-to-end in the exhaust pipe section with the preheating body located closer to the engine;
a heating pipe being externally fitted around the preheating body and the catalyst bed; the heating pipe having two closed ends, one of the two closed ends having a gas inlet pipe connected thereto to communicate the heating pipe with a combustion gas tank, and the other closed end of the heating pipe being provided with pressure relief vents; and
a plurality of heating catalysts being filled between the heating pipe and the preheating body and the catalyst bed; the heating catalysts being heated by a combustion gas fed from the combustion gas tank into the heating pipe, and the heated heating catalysts in turn heating the catalyst bed and the preheating body.

2. The hydrogen-producing catalytic converter as claimed in claim 1, wherein the catalyst bed further includes a first temperature sensor and a second temperature sensor; a fuel-water solution being supplied from the fuel-water solution tank into the preheating duct in the preheating body when the first temperature sensor detects a temperature reaching a working temperature of the hydrogen-producing catalysts for hydrogen production; and a coolant being supplied from the coolant tank into the coolant conveying duct in the catalyst bed when the second temperature sensor detects a temperature reaching a safe temperature preset for the hydrogen-producing catalysts.

3. The hydrogen-producing catalytic converter as claimed in claim 1, wherein the catalyst bed is provided at a front end surface opposite to the preheating body and a rear end surface with a plurality of front and rear recesses, respectively; every front and rear recess being provided with two axially extended through holes, and the two through holes at any one of the front recesses of the catalyst bed being communicable with two adjacent rear recesses of the catalyst bed; and the front recesses and the rear recesses of the catalyst bed being closed by front sealing plates and rear sealing plates, respectively, so that the molecular rearrangement duct forms a zigzag duct consisting of a plurality of sequentially communicable duct sections.

4. The hydrogen-producing catalytic converter as claimed in claim 1, wherein the preheating body is provided at a front end surface adjacent to the catalyst bed and a rear end surface with a plurality of front and rear recesses, respectively; every front and rear recess being provided with two axially extended through holes, and the two through holes at any one of the front recesses of the preheating body being communicable with two adjacent rear recesses of the preheating body; and the front recesses and the rear recesses of the preheating body being closed by front sealing plates and rear sealing plates, respectively, so that the preheating duct forms a zigzag duct consisting of a plurality of sequentially communicable duct sections.

5. The hydrogen-producing catalytic converter as claimed in claim 1, wherein the combustion gas is methanol steam.

6. The hydrogen-producing catalytic converter as claimed in claim 5, wherein the hydrogen-producing catalysts in the catalyst bed are CuZn-based catalysts.

7. The hydrogen-producing catalytic converter as claimed in claim 1, wherein the combustion gas contains oxygen and is supplied from the combustion gas tank into the heating pipe by an air pump.

8. The hydrogen-producing catalytic converter as claimed in claim 7, wherein the air pump immediately stops supplying the oxygen-containing combustion gas when the hydrogen-producing catalysts in the catalyst bed are heated by the heating catalysts in the heating pipe to a working temperature thereof.

9. The hydrogen-producing catalytic converter as claimed in claim 1, wherein the preheating body and the catalyst bed are provided on around their outer wall surfaces with at least three angularly equally spaced and axially extended support wings, and the heating pipe is correspondingly provided on its inner wall surface with axially extended engaging slots; wherein, through engagement of the support wings with the engaging slots, the preheating body and the catalyst bed are fixedly held in place in the heating pipe.

10. The hydrogen-producing catalytic converter as claimed in claim 9, wherein the preheating body and the catalyst bed are welded together to form an integral unit.

11. The hydrogen-producing catalytic converter as claimed in claim 9, wherein the support wings are respectively provided with a hole; and, with the holes provided on the support wings, gases in the heating pipe being allowed to flow laterally without being blocked by the support wings.

12. The hydrogen-producing catalytic converter as claimed in claim 1, wherein the heating pipe is fixedly held in the exhaust pipe section by two sets of at least three angularly equally spaced screws, which are provided on the exhaust pipe section near both front and rear ends thereof to radially extend into the exhaust pipe section to press against front and rear end portions of the heating pipe.

13. The hydrogen-producing catalytic converter as claimed in claim 1, wherein the heating catalysts are platinum catalysts.
